(19) United States
(12) Patent Application Publication
(10) Pub. No.: US 2007/0168864 A1
(43) Pub. Date: Jul. 19, 2007

(54) Video summarization apparatus and method

(76) Inventors: Koji Yamamoto, Tokyo (JP); Tatsuya Uehara, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/647,151

(22) Filed: Dec. 29, 2006

(30) Foreign Application Priority Data
Jan. 11, 2006 (JP) 2006-003973

(51) Int. Cl. G06F 3/00; G06F 17/00

(52) U.S. Cl. 715/716; 707/104.1

(57) ABSTRACT

A video summarization apparatus stores, in memory, video data including video and audio, and metadata items corresponding to video segments included in the video data respectively, each of metadata items including keyword and characteristic information of content of corresponding video segment, selects metadata items including specified keyword from metadata items, to obtain selected metadata items, extracts, from video data, video segment corresponding to selected metadata items, to obtain selected video segments, generates summarized video data by connecting extracted video segments, detects audio breakpoints included in video data, to obtain audio segments segmented by audio breakpoints, extracts from video data, audio segments corresponding to extracted video segments as audio narrations, and modifies ending time of video segment in summarized video data so that ending time of video segment in summarized video data coincides with or is later than ending time of corresponding audio segment of extracted audio segments.

### CROSS-REFERENCE TO RELATED APPLICATIONS

This application is based upon and claims the benefit of priority from prior Japanese Patent Application No. 2006-003973, filed Jan. 11, 2006,the entire contents of which are incorporated herein by reference.

### BACKGROUND OF THE INVENTION

1.Field of the Invention

This invention relates to a video summarization apparatus and a video summarization method.

2.Description of the Related Art

One conventional video summarization apparatus is extracts a segment of great importance from metadata-attached video on the basis of the user's preference and generates a narration that describes the present score and the play made by each player on the screen according to the contents of the video as disclosed in Jpn. Pat. Appln. KOKAI No. 2005-109566. Here, metadata includes the content of an event (e.g., a shot in soccer or a home run in baseball) occurred in the live TV output of sports and time information. The narration used in the apparatus was generated from metadata and the voice originally included in the video was not used for narration. Therefore, to generate a narration that describes the play scene by scene in detail, metadata describing the contents of the play in detail was needed. Since it was difficult to generate such metadata automatically, it was necessary to input such metadata manually, resulting in a bigger burden.

As described above, to add a narration to summarized video data in the prior art, metadata describing the content of video was required. This caused a problem: to explain the content of video in further detail, a large amount of metadata had to be generated beforehand.

### BRIEF SUMMARY OF THE INVENTION

According to embodiments of the present invention, a video summarization apparatus (a) stores video data including video and audio in a first memory; (b) stores, a second memory, a plurality of metadata items corresponding to a plurality of video segments included in the video data respectively, each of the metadata items including a keyword and characteristic information of content of corresponding video segment; (c) selects metadata items each including a specified keyword from the metadata items, to obtain selected metadata items; (d) extracts, from the video data, video segments corresponding to the selected metadata items, to obtain extracted video segments; (e) generates summarized video data by connecting extracted video segments in time series; (f) detects a plurality of audio breakpoints included in the video data, to obtain a plurality of audio segments segmented by the audio breakpoints; (g) extracts from the video data, audio segments corresponding to the extracted video segments as audio narrations; and (h) modifies an ending time of a video segment in the summarized video data so that the ending time of the video segment in the summarized video data coincides with or is later than an ending time of corresponding audio segment of the extracted audio segments.

### BRIEF DESCRIPTION OF THE SEVERAL VIEWS OF THE DRAWING

FIG. 1 is a block diagram showing an example of the configuration of a video summarization apparatus according to a first embodiment of the present invention;

FIG. 2 is a flowchart for explaining the processing in the video summarization apparatus;

FIG. 3 is a diagram for explaining the selection of video segments to be used as summarized video and the summarized video;

FIG. 4 shows an example of metadata;

FIG. 5 is a diagram for explaining a method of detecting breakpoints using the magnitude of voice;

FIG. 6 is a diagram for explain a method of detecting breakpoints using a change of speakers;

FIG. 7 is a diagram for explaining a method of detecting breakpoints using sentence structure;

FIG. 8 is a flowchart for explaining the operation of selecting an audio segment whose content does not include a narrative;

FIG. 9 is a block diagram showing an example of the configuration of a video summarization apparatus according to a second embodiment of the present invention;

FIG. 10 is a diagram for explaining the operation of a volume control unit;

FIG. 11 is a flowchart for explaining the processing in the video summarization apparatus of FIG. 9;

FIG. 12 is a block diagram showing an example of the configuration of a video summarization apparatus according to a third embodiment of the present invention;

FIG. 13 is a diagram for explaining an audio segment control unit;

FIG. 14 is a flowchart for explaining the processing in the video summarization apparatus of FIG. 12;

FIG. 15 is a block diagram showing an example of the configuration of a video summarization apparatus according to a fourth embodiment of the present invention;

FIG. 16 is a flowchart for explaining the processing in the video summarization apparatus of FIG. 15;

FIG. 17 is a diagram for explaining the process of selecting a video segment;

FIG. 18 is a diagram for explaining the process of generating a narrative (or narration) of summarized video; and

FIG. 19 is a diagram for explaining a method of detecting a change of speakers.

### DETAILED DESCRIPTION OF THE INVENTION

Hereinafter, referring to the accompanying drawings, embodiments of the present invention will be explained.

### FIRST EMBODIMENT

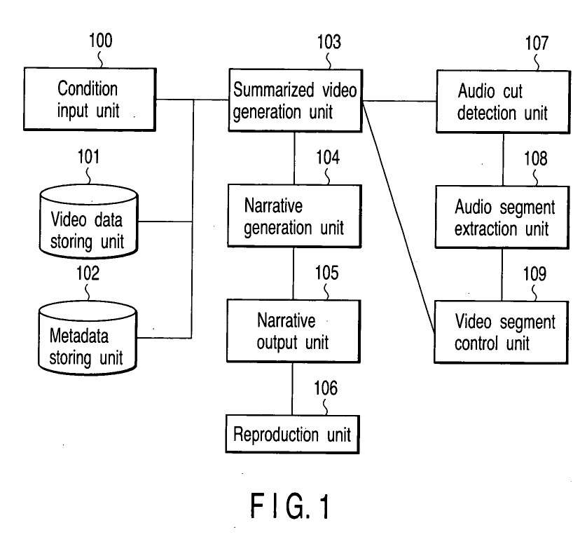

FIG. 1 is a block diagram showing an example of the configuration of a video summarization apparatus according to a first embodiment of the present invention.

The video summarization apparatus of FIG. 1 includes a condition input unit 100, a video data storing unit 101, a metadata storing unit 102, a summarized video generation unit 103, a narrative generation unit 105, a narrative output unit 105, a reproduction unit 106, an audio cut detection unit 107, an audio segment extraction unit 108, and a video segment control unit 109.

The video data storing unit 101 stores video data including images and audio. From the video data stored in the video data storing unit 101, the video summarization apparatus of FIG. 1 generates summarized video data and a narration corresponding to the summarized video data.

The metadata storing unit 102 stores metadata includes expression of the contents of each video segment in the video data stored in the video data storing unit 101. The time or the frame number counted from the beginning of the video data stored in the video data storing unit 101 relate the metadata to the video data one another. For example, the metadata corresponding to a certain video segment includes the beginning time and ending time of the video segment. The beginning time and ending time included in a metadata relate the metadata to the corresponding video segment in the video data. When a predetermined duration whose center corresponds to a time when a certain event occurred in the video data is set as a video segment, the metadata corresponding to the video segment includes the time the event occurred, then the time the event occurred included in the metadata relates the metadata to the video segment whose center corresponds to the time the event occurred. When a video segment is from its beginning time until the beginning time of the next video segment, the metadata corresponding to the video segment includes the beginning time of the video segment, then the beginning time included in the metadata relates the metadata to the video segment. Moreover, in place of time, the frame number of the video data may be used. An explanation will be given of a case where metadata includes a time an arbitrary event occurred in the video data and the metadata and corresponding video segment are related by the occurrence time the event occurred. In this case, a video segment includes video data in a predetermined time segment centering on the occurrence time when an event occurred.

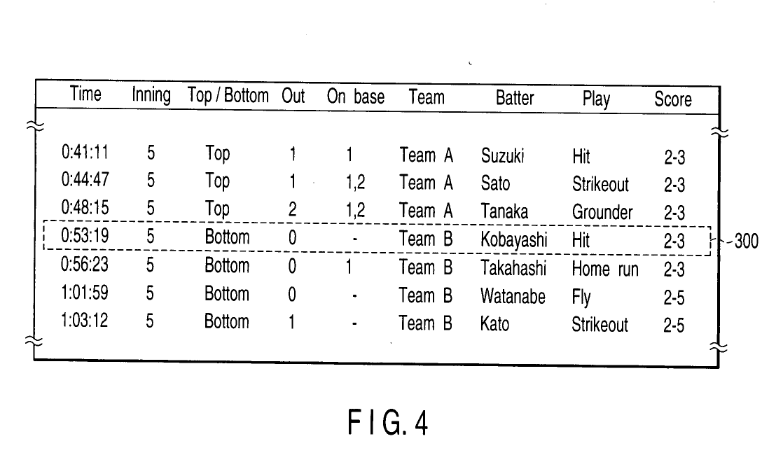

FIG. 4 shows an example of the metadata stored in the metadata storing unit 102 when the video data stored in the video data storing unit 101 is video data about a relayed broadcast of baseball.

In the metadata shown in FIG. 4, the time (or time code) when hit, strikeout, home run, and the like occurred, and the inning the batter had a turn at bat, the top or bottom half, out count, on-base state, team name, batter's name, score, and the like when such event (as the result of batting, including hits, strikeouts, and home runs) occurred have been written by item. The items shown in FIG. 4 are illustrative and items differing from those of FIG. 4 may be used.

To the condition input unit 100, a condition for retrieving a desired video segment from the video data stored in the video data storing unit 101 is input.

The summarized video generation unit 103 selects metadata that satisfies the condition input from the condition input unit 100 and generates summarized video data on the basis of the video data in the video segment corresponding to the selected metadata.

The narrative generation unit 104 generates a narrative of the summarized video from the metadata satisfying the condition input at the condition input unit 100. The narrative output unit 105 generates and a synthesized voice and a text for the generated narrative (or either the synthesized voice or the text for the narrative) and outputs the results. The reproduction unit 106 reproduces the summarized video data and the synthesized voice and text for the narrative (or either the synthesized voice or text for the narrative) in such a manner that the summarized video data synchronizes with the latter.

The audio cut detection unit 105 detects breakpoints in the audio included in the video data stored in the video data storing unit 101. On the basis of the detected audio breakpoints, the audio segment extraction unit 108 extracts from the audio included in the video data an audio segment used as narrative audio for the video segment for each video segment in the summarized video data. On the basis of the extracted audio segment, the video segment control unit 109 modifies the video segment in the summarized video generated at the summarized video generation unit 103.

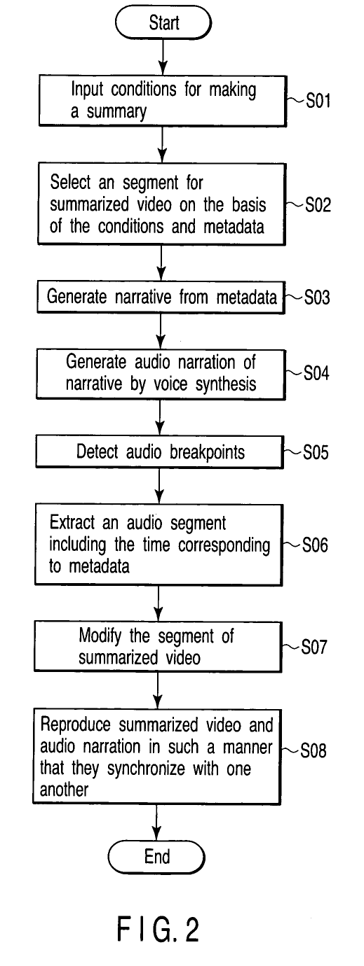

FIG. 2 is a flowchart to help explain the processing in the video summarization apparatus of FIG. 1. Referring to FIG. 2, the processing in the video summarization apparatus of FIG. 1 will be explained.

First, at the condition input unit 100, a keyword that indicates the user's preference, the reproducing time of the entire summarized video, and the like serving as a condition for the generation of summarized video are input (step S01).

Next, the summarized video generation unit 103 selects an metadata item that satisfies the input condition from the metadata stored in the metadata storing unit 102. For example, the summarized video generation unit 103 selects the metadata item including the keyword specified as the condition. And the summarized video generation unit 103 selects the video data for the video segment corresponding to the selected metadata item from the video data stored in the video data storing unit 101 (step S02).

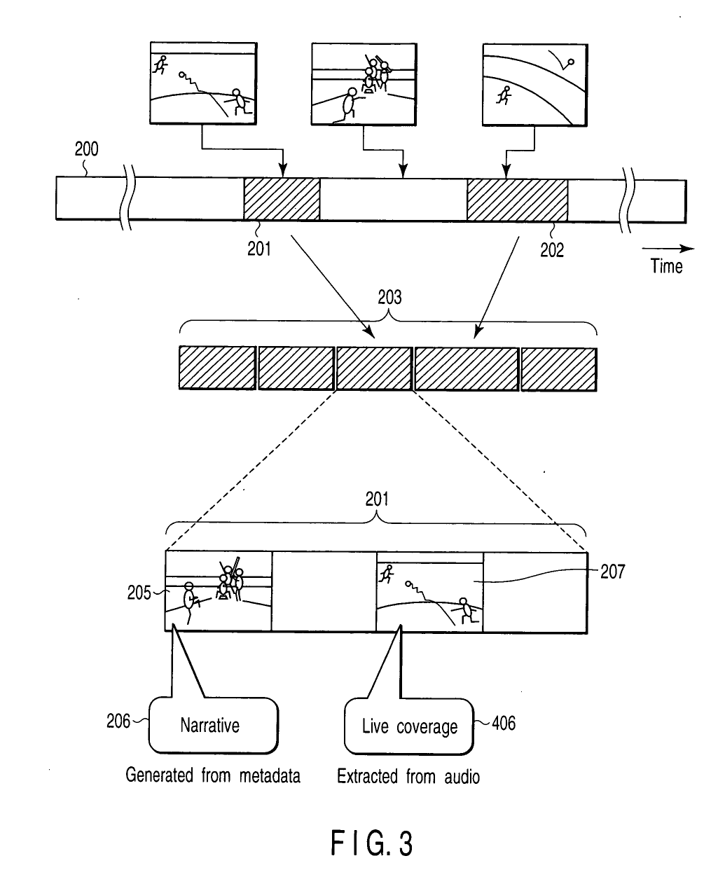

Here, referring to FIG. 3, the process in step S02 will be explained more concretely. FIG. 3 shows a case where the video data stored in the video data storing unit 101 is video data about a relayed broadcast of baseball. Metadata on the video data is assumed to be shown in FIG. 4.

In step S01, keywords, including “team B” and “hit”, input as conditions are input. In step S02, metadata items including these keywords is retrieved and the video segments 201, 202, and the like corresponding to the retrieved metadata items are selected. As described later, after the lengths of these selected video segments are modified, the video data items in the modified video segments modified are connected in time sequence, thereby generating summarized video data 203.

Video segments can be selected using the method disclosed in, for example, Jpn. Pat. Appln. KOKAI No. 2004-126811 (content information editing apparatus and editing program). Hereinafter, the process of selecting video segments will be explained using a video summarization process as an example.

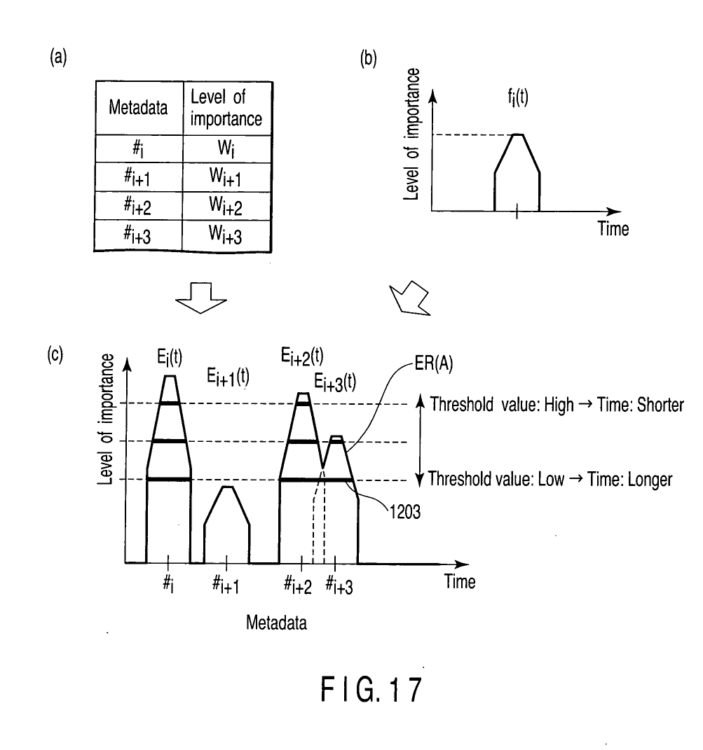

FIG. 17 is a diagram to help explain a video summarization process. In the example of FIG. 4, only the occurrence time of each metadata item has been written and the beginning and end of the segment have not been written. In this method, metadata item to be included in the summarized video is selected and, at the same time, the beginning and end of each segment are determined.

First, the metadata items are compared with the user's preference, thereby calculating the level of importance wᵢfor each metadata item as shown in FIG. 17(a).

Next, from the level of importance of metadata item and an importance function as shown in FIG. 17(b), Eᵢ(t) representing the temporal change in the level of importance of each metadata item is calculated. The importance function fᵢ(t) is a function of time t modeled on change in the level of importance of an i-th metadata item. Using the importance function, an importance curve Eᵢ(t) of the i-th metadata item is defined by the following equation:
Eᵢ(t)=(1+wᵢ)fᵢ(t)

Next, from the importance curve of each event, as shown in FIG. 17(c), an importance curve ER(t) of all the video content is calculated using the following equation, where Max(Eᵢ(t)) represents the maximum value of Eᵢ(t):
ER(t)=Max(Eᵢ(t))

Finally, like the segment 1203 shown by a bold line, an segment where the importance curve ER(t) of all the content is larger than a threshold value ERₜₕis extracted and used as summarized video. The smaller (or lower) the threshold value ERₜₕ, the longer the summarized video segment becomes. The larger (or higher) the threshold value ERₜₕ, the shorter the summarized video segment becomes. Therefore, the threshold value ERₜₕ is so determined that the total time of the extracted segments satisfies the entire reproducing time included in the summarization generating condition.

As described above, from the metadata items and the user's preference included in the summarization generating condition, the segments to be included in the summarized video are selected.

The details of the above method have also been disclosed in, for example, Jpn. Pat. Appln. KOKAI No. 2004-126811(content information editing apparatus and editing program).

Next, the narrative generation unit 104 generates a narrative from the retrieved metadata item(step S03). A narrative can be generated by the method disclosed in, for example, Jpn. Pat. Appln. KOKAI No. 2005-109566. Hereinafter, the generation of a narrative will be explained using the generation of a narration of summarized video as an example.

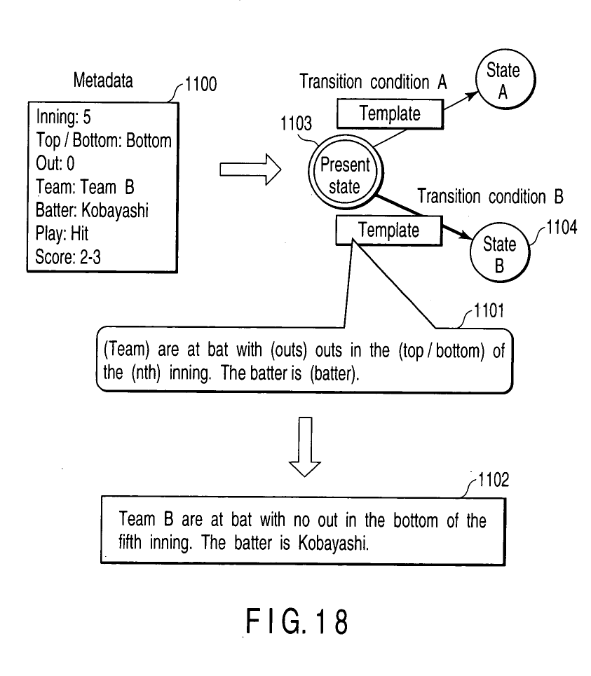

FIG. 18 is a diagram for explaining the generation of a narration of summarized video. A narration is generated by applying metadata item to a sentence template. For example, metadata item 1100 is applied to a sentence template 1101, thereby generating a narration 1102. If the same sentence template is used each time, this produces only uniform narrations, which is unnatural.

To generate a natural narration, a plurality of sentence templates are prepared and they may be switched according to the content of video. A state transition model reflecting the content of video is created, thereby managing the state of the game. When metadata item has been input, transition takes place on the state transition model and a sentence template is selected. Transition condition is defined using the items included in the metadata item.

In the example of FIG. 18, node 1103 represents the state before the metadata item is input. When the state transits to state 1104 after the metadata item 1100 has been input, the corresponding template 1101 is selected. Similarly, a template is associated with each transition from one node to another node. If the transition takes place, a sentence template is selected. In fact, the number of state transition model is not only one. There are a plurality of models, including a model for managing the score and a model for managing the batting state. Metadata item is generated by integrating the narrations obtained from these state transition models. In the example of obtained score, different transitions are followed in “tied score,”“come-from-behind score,” and “added score.” Even in the narration of the same runs, a sentence is generated according to the state of the game.

For example, suppose metadata in the video segment 201 is metadata item 300 of FIG. 4. The metadata 300 describes the event (that the batter got a hit) occurred at time “0:53:19” in the video data. From the metadata item, the narrative “Team B is at bat in the bottom of the fifth inning. The batter is Kobayashi” is generated.

Of the video data in the video segment 201, the generated narrative is a narrative 206 corresponding to the video data 205 in the beginning part (no more than several frames of the beginning part) of the video segment 201 in FIG. 3.

Next, the narrative output unit 105 generates a synthesized voice for the generated narrative, that is, an audio narration (step S04).

Next, the audio cut detection unit 107 detects audio breakpoints included in the video data (step S05). As an example, let an segment where sound power is lower than a specific value be a silent segment. A breakpoint is set at an arbitrary time point in a silent segment (for example, the midpoint of the silent segment or a time point after a specific time elapses since the beginning time of the silent segment),

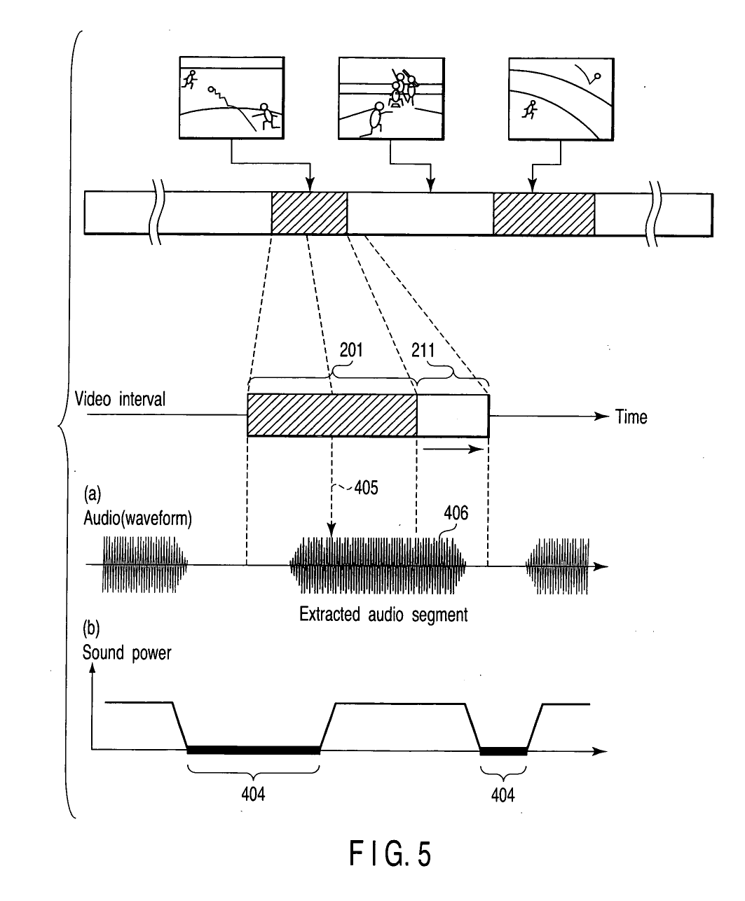

Here, referring to FIG. 5, a method of detecting breakpoints at the audio cut detection unit 107 will be explained. FIG. 5 shows the video segment 201 obtained in step S02, an audio waveform (FIG. 5(a)) in the neighborhood of the video segment 201, and its sound power (FIG. 5(b)).

If sound power is P, an segment satisfying the expression P<Pth is set as a silent segment. Pth is a predetermined threshold value to determine an segment to be silent. In FIG. 5(b), the audio cut detection unit 107 determines an segment shown by a bold line where sound power is lower than the threshold value Vth to be a silent segment 404 and sets an arbitrary time point in each silent segment 404 as a breakpoint. Let an segment from one breakpoint to another be an audio segment.

Next, the audio segment extraction unit 108 extracts an audio segment used as narrative audio for the each video segment selected in step S02 from the audio segments which are in the neighborhood of the each video segment (step S06).

For example, the audio segment extraction unit 108 select and extract an audio segment including the beginning time of the video segment 201 and the occurrence time of the event in the video segment 201 (here, the time written in metadata item). Alternatively, the audio segment extraction unit 108 select and extract an audio segment occurring at the time closest to the beginning time of the video segment 201 or the occurrence time of the event in the video segment 201.

In FIG. 5, if the occurrence time of the event (that the batter got a hit) in the video segment 201 is at 405, the audio segment 406 including the occurrence time of the event is selected and extracted. Suppose the audio segment 406 is the play-by-play audio of the image 207 of the scene where the batter actually got a hit in FIG. 3.

Next, the audio segment control unit 109 modifies the length of each video segment used as summarized video according to the audio segment extracted for each video segment selected in step S02 (step S07). This is possible by extending the video segment so as to completely include the audio segment corresponding to the video segment.

For example, in FIG. 5, the audio segment 406 extracted for the video segment 201 lasts beyond the ending time of the video segment 201. In this case, to modify the video segment so as to completely include the audio segment 406, subsequent vide data 211 with a specific duration is added to the video segment 201, thereby extending the ending time of the video segment 201. That is, the modified video segment 201 is an segment obtained by adding the video segment 201 and the video segment 211.

Alternatively, the ending time of the video segment may be modified in such a manner that the ending time of each video segment selected in step S02 coincides with the breakpoint of the ending time of the audio segment extracted for the each video segment.

Moreover, the beginning time and ending time of the video segment may be modified in such a manner that the beginning time and ending time of each video segment selected in step S02 include the breakpoints of the beginning time and ending time of the audio segment extracted for the video segment.

In addition, the beginning time and ending time of the video segment may be modified in such a manner that the beginning time and ending time of each video segment selected in step S02 coincide with the breakpoints of the beginning time and ending time of the audio segment extracted for the video segment.

In this way, the audio segment control unit 109 modifies each video segment used as summarized video generated at the summarized video generation unit 103.

Next, the reproduction unit 106 reproduces the summarized video data (the video and narrative audio in the video segment (or the modified video segment if a modification was made)) obtained by connecting time-sequentially the video data in each of the modified video segments generated by the above processes and the audio narration of the narrative generated in step S04 in such a manner that the summarized video data and the narration are synchronized with one another (step S08).

As described above, according to the first embodiment, it is possible to generate summarized video including video data segmented on the basis of the audio breakpoints and therefore to obtain not only the narration of a narrative generated from the metadata on the summarized video but also detailed information on the video included in the summarized video from the audio included in the video data of the summarized video. That is, since information on the summarized video can be obtained from the audio information originally included in the video data of the summarized video, it is not necessary to generate detailed metadata to generate a detailed narrative. Metadata has only to have as much information as can be used as an index for retrieving a desired scene, which enables the burden of generating metadata to be alleviated.

(Another Method Of Detecting Audio Breakpoints)

While in step S05 of FIG. 2, a breakpoint has been detected by detecting a silent segment or a low-sound segment included in the video data, a method of detecting a breakpoint is not limited to this.

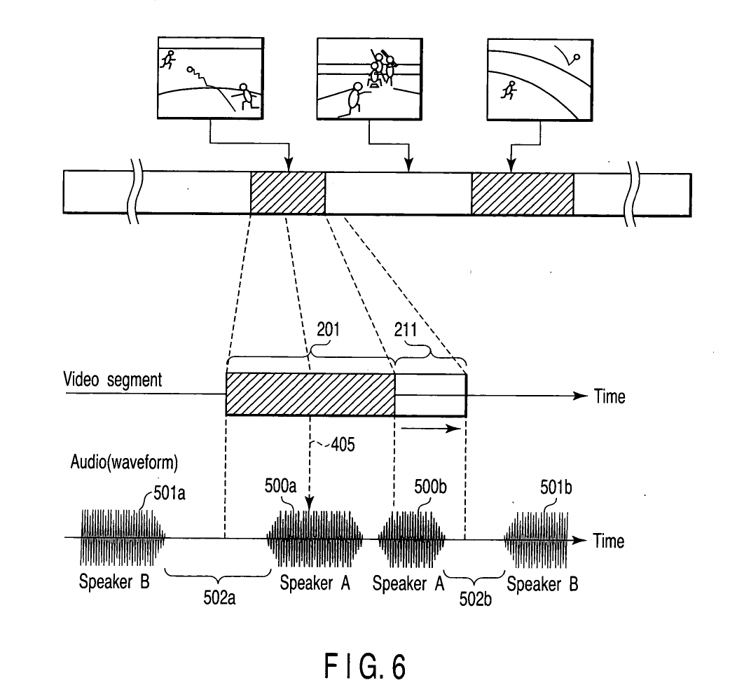

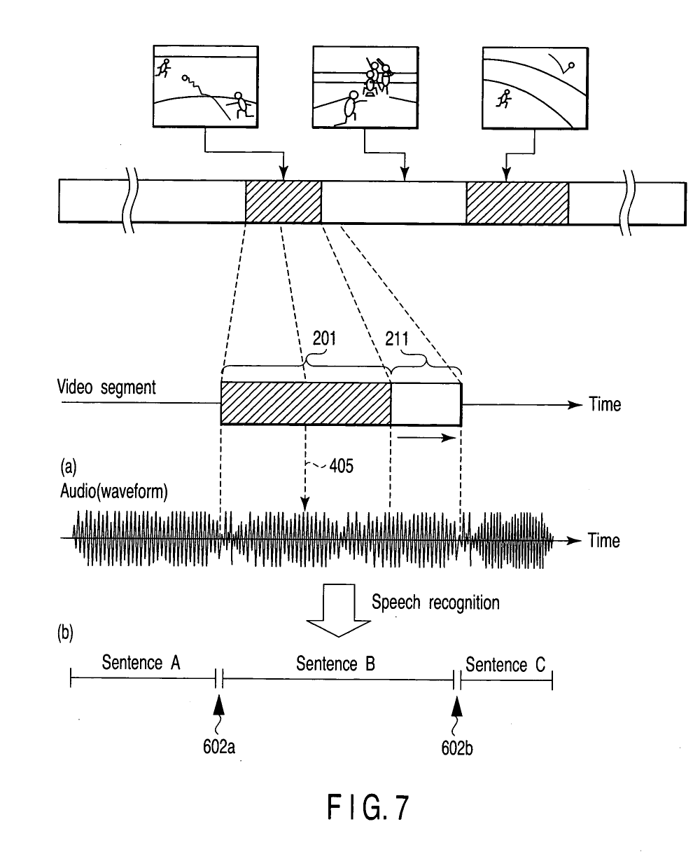

Hereinafter, referring to FIGS. 6 and 7, another method of detecting an audio breakpoint at the audio cut detection unit 107 will be explained.

FIG. 6 is a diagram for explaining a method of detecting a change (or switching) of speakers as an audio breakpoint, when there are pluralities of speakers. A change of speakers can be detected by the method disclosed in, for example, Jpn. Pat. Appln. KOKAI No. 2003-263193 (a method of automatically detecting a change of speakers with a speech-recognition system).

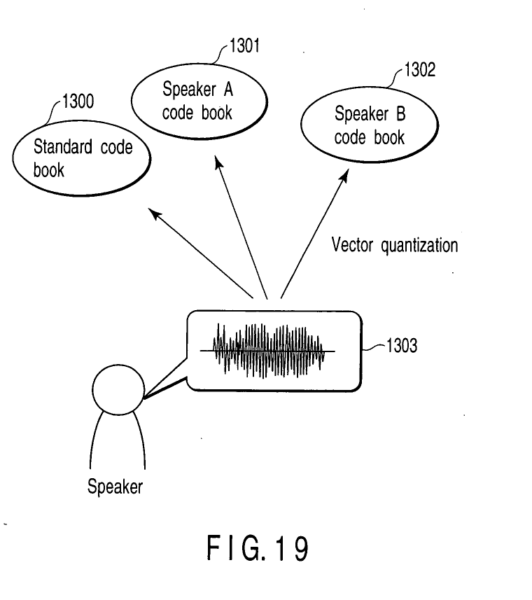

FIG. 19 is a diagram for explaining the process of detecting a change of speakers. In a speech-recognition system using a semicontinuous hidden Markov model SCHMM, a plurality of code books each obtained by learning each speaker are prepared in addition to a standard code book 1300. Each code book is composed of an nth-degree normal distribution and is expressed by a mean-value vector p and its covariant matrix K. The code book corresponding to each speaker is such that the mean-value vectors and/or covariant matrixes is unique on the each speaker. For example, a code book 1301 adapted to speaker A and a code book 1302 adapted to speaker B are prepared.

The speech-recognition system correlates a code book independent of a speaker with a code book dependent on the speaker by vector quantization. On the basis of the correlation, the speech-recognition system allocates an audio signal to the relevant code book, thereby determining the speaker's identity. Specifically, each of the feature vectors obtained from the audio signal 1303 is vector-quantized into the individual normal distributions included in all of the code books 1300 to 1302. When a k number of normal distributions are included in a code book, let the probability of each normal distribution be p(x, k). If in each code book, the number of provability values larger than a threshold value is N, a normalization coefficient F is determined using the following equation:
F=1/(p(x,2)+p(x,2)+−+p(x,N))

A normalization coefficient is a coefficient that is multiplied by a probability value larger than the threshold value, enabling its total to be made “1”. As the audio feature vector approaches the normal distribution of any one of the code books, the probability value becomes larger. That is, the normalization coefficient becomes smaller. Selecting the code book whose normalization coefficient is the smallest makes it possible to distinguish the speaker and further detect a change of speakers.

In FIG. 6, if the audio segments 500a and 500b where speaker A was speaking and the audio segments 501a and 501b where speaker B was speaking have been detected, the segments 502a and 502b where speakers are changed are determined. Therefore, an arbitrary time point (e.g., intermediate time) in the segments 502aand 502b (the segments where speakers are changed) each being from when a certain speaker finishes speaking until another speaker starts to speak are set as breakpoints.

In FIG. 6, the audio segment including the occurrence time 405 of the event (that the batter got a hit) in the video segment 201 and including the speech segments 500a and 500b of speaker A closest to the video segment 201 is selected and extracted by the audio segment extraction unit 108.

The audio segment control unit 109 adds to the video segment 201, the video data 211 of a specific duration subsequent to the video segment 201, so that the modified video segment may include the extracted audio segment completely, thereby extending the ending time of the video segment 201.

FIG. 7 is a diagram for explaining a method of breaking down audio in the video data into sentences and phrases and detecting the pauses as breakpoints in the audio. It is possible to break down audio into sentences and phrases by converting audio into text by speech recognition and subjecting the text to natural language processing. Suppose three sentences A to C as shown in FIG. 7(b) are obtained by speech-recognizing audio in the video segment 201 in the video data as shown in FIG. 7(a) and the preceding and following time segments. At this time, the sentence turning points 602a, 602b are set as breakpoints. Similarly, pauses in the phrases or words may be used as breakpoints.

In FIG. 7, the audio segment which corresponds to sentence B and includes the occurrence time 405 of the event (that the batter got a hit) in the video segment 201 and is closest to the video segment 201 is selected and extracted by the audio segment extraction unit 108.

The audio segment control unit 109 adds to the video segment 201, video data 211 of specific duration subsequent to the video segment 201, so that the modified video segment may include the extracted audio segment completely, thereby extending the ending time of the video segment 201.

Since in the methods of detecting audio breakpoints shown in FIGS. 6 ad 7, breakpoints are determined according to the content of audio, it is possible to delimit well-organized audio segments as compared with a case where silent segments are detected as shown in FIG. 5.

(Another Method Of Extracting Audio Segments)

While in step S06 of FIG. 2, an audio segment used as narrative audio in each video segment included in summarized video data have been determined according to the relationship between the occurrence time of the event included in metadata item corresponding to each video segment and the temporal position of the audio segment, a method of selecting an audio segment is not limited to this.

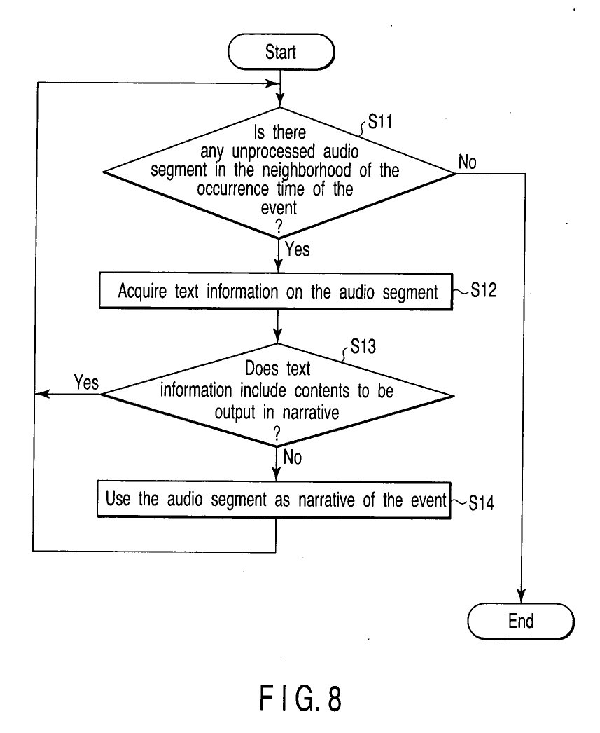

Next, referring to a flowchart shown in FIG. 8, another method of extracting an audio segment will be explained.

First, each video segment included in summarized video is checked to see if there is an unprocessed audio segment in the neighborhood of the occurrence time of the event included in metadata item corresponding to the video segment (step S11). The neighborhood of the occurrence time of the event means, for example, an segment between t−t1 (seconds) to t−t2 (seconds) if the occurrence time of the event is t (seconds). Here, t1 and t2 (seconds) are threshold values. Alternatively, the video segment may be used as a reference. Let the beginning time and ending time of the video segment be ts (seconds) and te (seconds), respectively. Then, ts−tl (seconds) to te+t2 (seconds) may set as the neighborhood of the occurrence time of the event.

Next, one of the unprocessed audio segments included in the segment near the occurrence time of the event is selected and text information is acquired (step S12). The audio segment is an segment delimited at the breakpoints detected in step S05. Text information can be acquired by speech recognition. Alternatively, when subtitle information corresponding to audio or text information, such as closed captions, is provided, it may be used.

Next, it is determined whether the text information includes the content output as a narrative in step S03 (step S13). This determination can be made according to whether text information includes metadata item from which a narrative, such as “obtained score,” is generated. If the text information includes the content except for a narrative, control proceeds to step S14. If the text information doesn't include the content except for a narrative, control proceeds to step S11. This is repeated until the unprocessed audio segments have run out in step S11.

If the text information includes content except for the narrative, the audio segment is used as narrative audio for the video segment (step S14).

As described above, for each of the video segments used as summarized video data, an audio segment including content except for the narrative generated from metadata item corresponding to the video segment is extracted, which makes it possible to prevent the use of audio in an audio segment in which its content overlap with the narrative and therefore which is redundant and unnatural.

### SECOND EMBODIMENT

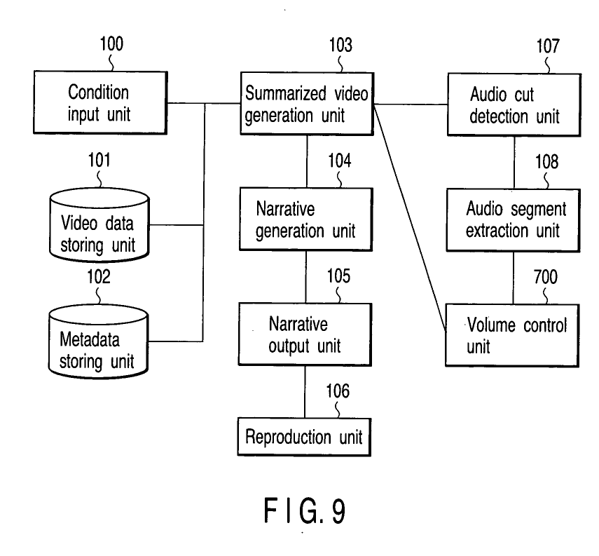

Referring to FIGS. 9, 10, and 11, a second embodiment of the present invention will be explained. FIG. 9 is a block diagram showing an example of the configuration of a video summarization apparatus according to a second embodiment of the present invention. In FIG. 9, the same parts as those in FIG. 1 are indicated by the same reference numerals. Only what differs from FIG. 1 will be explained. In FIG. 9, instead of the video segment control unit 109, a volume control unit 700 for adjusting the sound volume of summarized video data is provided.

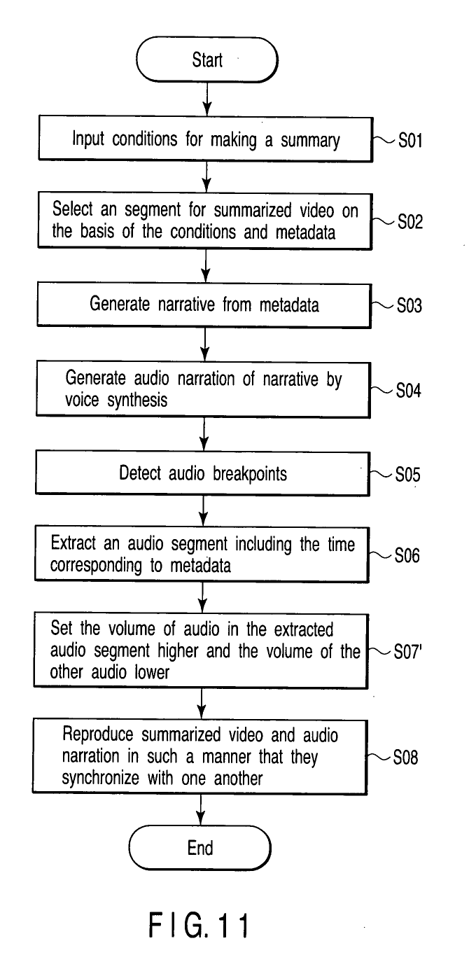

The video segment control unit 109 of FIG. 1 modifies the temporal position of the video segment according to the extracted audio segment, in step S07 of FIG. 2, whereas the volume control unit 700 of FIG. 2 adjust the sound volume as shown in step S07′ of FIG. 11. That is, the sound volume of audio in the audio segment extracted as narrative audio for the video segment included in summarized video data is set larger. The sound volume of audio except for narrative audio is set lower.

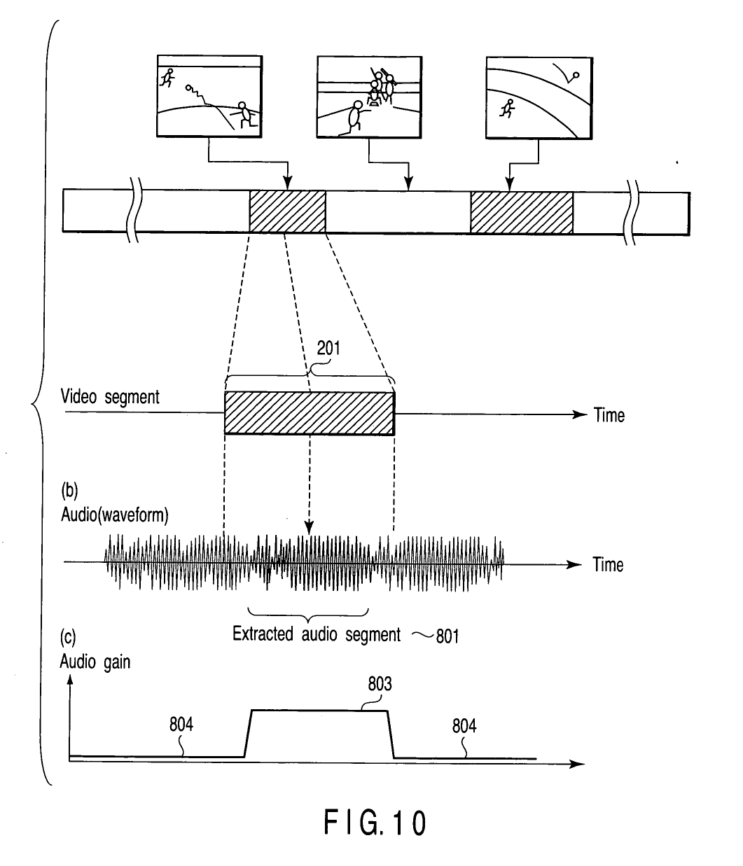

Next, referring to FIG. 10, the processing in the volume control unit 700 will be explained. Suppose the audio segment extraction unit 108 has extracted an audio segment 801 corresponding to the video segment 201 included in summarized video. At this time, as shown in FIG. 10(c), the volume control unit 700 sets the audio gain higher than a first threshold value in the extracted audio segment (or narrative audio) 803 and sets the audio gain lower than a second threshold value lower than the first threshold value in the part 804 except for the extracted audio segment (or narrative audio).

With the video summarization apparatus of the second embodiment, a suitable audio segment for the content of summarized video data is detected and used as narration, which makes detailed metadata for the generation of narration unnecessary. As compared with the first embodiment, it is unnecessary to modify each video segment in summarized video data, preventing a change in the length of the entire summarized video, which makes it possible to generate summarized video with a length precisely coinciding with the time specified by the user.

While in FIG. 9, the volume control unit 700 for adjusting the sound volume of summarized video data has been provided instead of the video segment control unit 109 of FIG. 1, the video segment control unit 109 may be added to the configuration of FIG. 9.

In this case, when in step S07′ of FIG. 11, the ending time of the extracted audio segment 406 for the video segment 201 is later than the ending time of the video segment 201 or the audio segment 406 is longer than the video segment 201, the video segment control unit 109 modifies the video segment 201. For example, in this case, the ending time of the video segment 201 is extended to the ending time of the audio segment 406. As a result, the audio segment extracted for each video segment in the summarized video data is in such a temporal position as and has such a length as is included completely in the video segment (like the audio segment 801 for the video segment 201 in FIG. 10), then the volume control unit 700 controls the sound volume. Specifically, the sound volume of narrative audio in each video segment in the summarized video data including the video segment whose ending time or whose ending time and beginning time have been modified at the video segment control 109 is set higher than the first threshold value and the sound volume of audio except for the narrative audio in the video segment is set lower than the second threshold value.

By the above operation, the sound volume is controlled and summarized video data including the video data in each of the modified video segments is generated. Thereafter, the generated summarized video data and a synthesized voice of a narrative are reproduced in step S08.

### THIRD EMBODIMENT

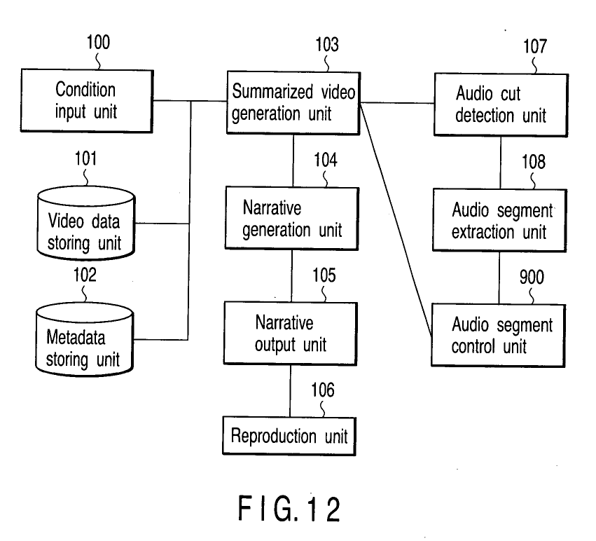

Referring to FIGS. 12, 13, and 14, a third embodiment of the present invention will be explained. FIG. 12 is a block diagram showing an example of the configuration of a video summarization apparatus according to a third embodiment of the present invention. In FIG. 12, the same parts as those in FIG. 1 are indicated by the same reference numerals. Only what differs from FIG. 1 will be explained. In FIG. 12, instead of the video segment control unit 109 of FIG. 1, there is provided an audio segment control unit 900 which shifts the temporal position for reproducing the audio segment extracted as narrative audio for a video segment in summarized video data.

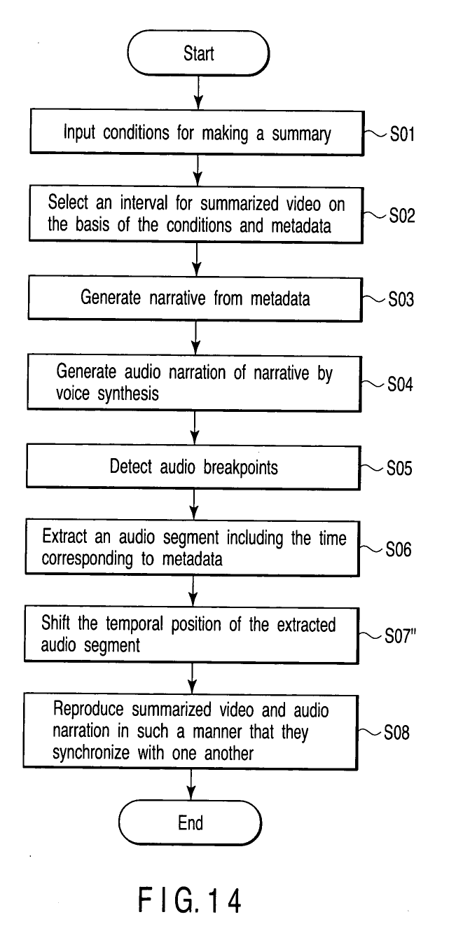

The video segment control unit 109 of FIG. 1 modifies the beginning time and ending time of the video segment according to the extracted audio segment in step S07 of FIG. 2, whereas the video summarization apparatus of FIG. 12 does not change the temporal position of the video segment and the audio segment control unit 900 shifts only the temporal position for reproducing the extracted audio segment extracted as narrative audio as shown in step S07″ of FIG. 14. That is, audio shifted from the original video data is reproduced.

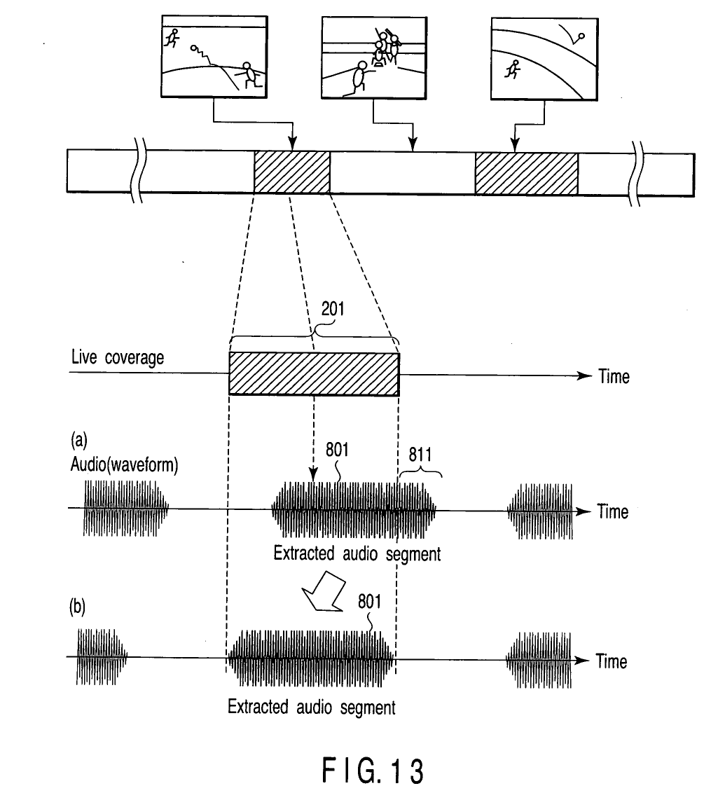

Next, referring to FIG. 13, the processing in the audio segment control unit 900 will be explained. Suppose audio segment 801 has been extracted as narrative audio for the video segment 201 included in summarized video. At this time, as shown in FIG. 13(a), if the segment 811 is the part that does not fit into the video segment 801, the temporal position for reproducing the audio segment 801 is shifted forward by the length of the time of the segment 811 (FIG. 13(b)). Then, the reproduction unit 106 reproduces the sound in the audio segment 801 at the temporal position shifted so as to fit into the video segment 201.

In the same way as above, when a starting time of the audio segment is earlier than a starting time of the corresponding video segment in the summarized video data and length of the audio segment is equal to or shorter than length of the corresponding video segment, the audio segment control unit 900 shifts, in step S07″ of FIG. 14, temporal position for reproducing the audio segment so that the temporal position lie within corresponding video segment. With the video summarization apparatus of the third embodiment, a suitable audio segment for the content of summarized video data is detected and used as narration, which makes detailed metadata for the generation of narration unnecessary. As compared with the first embodiment, it is unnecessary to modify each video segment in summarized video data, preventing a change in the length of the entire summarized video, which makes it possible to generate summarized video with a length precisely coinciding with the time specified by the user.

### FOURTH EMBODIMENT

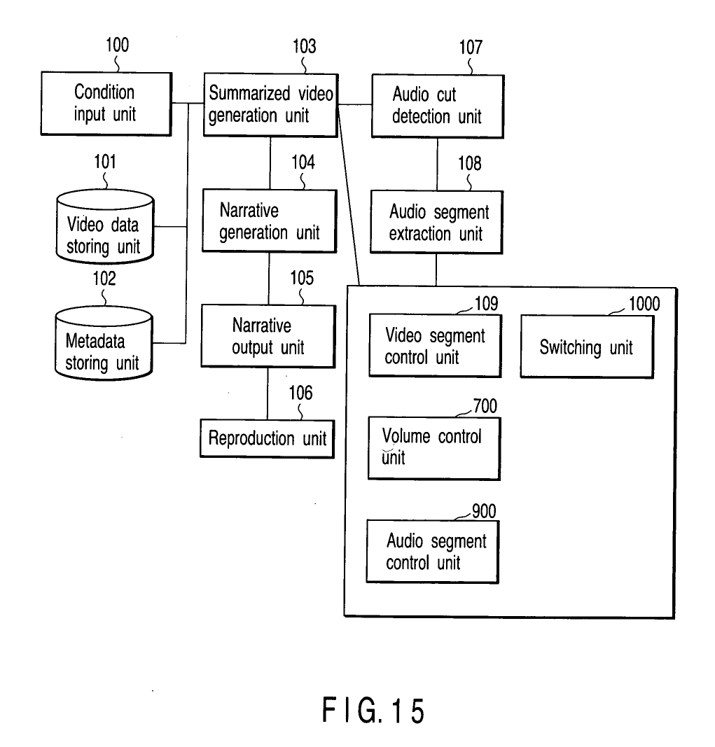

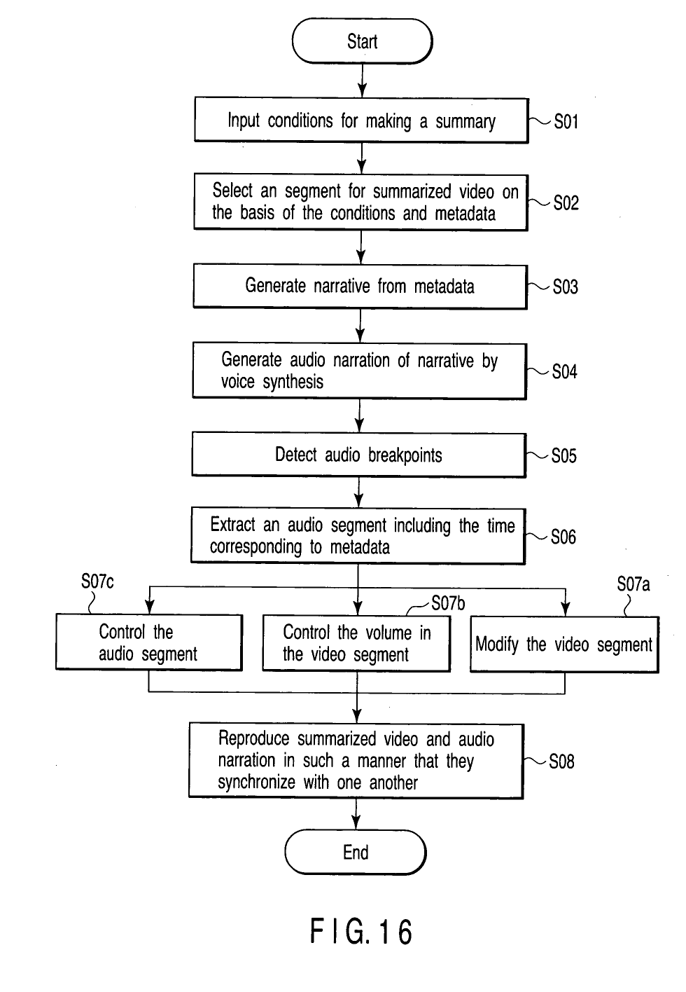

While in FIG. 12, the audio segment control unit 900 has been provided instead of the video segment control unit 109 of FIG. 1, the volume control unit 700 of the second embodiment and the video segment control unit 109 of the first embodiment may be further added to the configuration of FIG. 12 as shown in FIG. 15. In this case, a switching unit 1000 is added which, on the basis of each video segment in the summarized video data and the length and temporal position of the audio segment extracted as narrative audio for the video segment, selects any one of the video segment control unit 109, volume control unit 700, and audio segment control unit 800 for each video segment in the summarized video-data. FIG. 16 is a flowchart for explaining the processing in the video summarization apparatus of FIG. 15. FIG. 16 differs from FIGS. 2, 11, and 14 in that the switching unit 1000 selects any one of the video segment control unit 109, volume control unit 700, and audio segment control unit 800 for each video segment in the summarized video data, thereby modifying a video segment, controlling the sound volume, and controlling an audio segment.

Specifically, the switching unit 1000 checks each video segment in the summarized video data and the length and temporal position of the audio segment extracted for the video segment. If the audio segment is shorter than the video segment and the temporal position of the audio segment is included completely in the video segment (like the audio segment 801 for the video segment 201 in FIG. 10), the switching unit selects the volume control unit 700 for the video segment and controls the sound volume of the narrative audio in the video segment and the audio except for the narrative audio (step S07b).

Moreover, if the length of the audio segment 801 extracted for the video segment 201 is shorter than the video segment 201 and the ending time of the audio segment 801 is later than the ending time of the video segment 201 as shown in FIG. 13, the switching unit selects the audio segment control unit 900 and shifts the temporal position of the audio segment as explained in the third embodiment (step S07c). Thereafter, the switching unit 1000 selects the volume control unit 700 for the video segment and controls the sound volume of the narrative audio in the video segment and the audio except for the narrative audio as shown in the second embodiment (step S07b).

Furthermore, as shown in FIG. 5, if the length of the audio segment 406 extracted for the video segment 201 is longer than the video segment 201, the switching unit selects the video segment control unit 109 for the video segment 201 and modifies the ending time of the video segment or the ending time and beginning time of the video segment as explained in the first embodiment (step S07a). In this case, the switching unit 1000 may first select the video segment control unit 109, thereby extending the ending time of the video segment 201, which makes the length of the video segment 201 equal to or longer than that of the audio segment 406 (step S07a). Thereafter, the switching unit may select the audio segment control unit 900, thereby shifting the temporal position of the audio segment 406 so that the position may lie in the modified video segment 201 (step S07c). After modifying the video segment or modifying the video segment and shifting the audio segment, the switching unit 1000 selects the volume unit 700, thereby controlling the sound volume of the narrative audio in the video segment and the audio except for the narrative audio as shown in the second embodiment (step S07b).

By the above-described processes, summarized video data including the video segment modified, the audio segment shifted, the video segment whose sound volume is controlled is generated. Thereafter, the generated summarized video data and a synthesized voice of narrative are reproduced in step S08.

According to the first to fourth embodiments, it is possible to generate, from video data, summarized video data that enables the audio included in the video data to be used as narration to explain the content of the video data. As a result, it is not necessary to generate a detailed narrative for the video segment used as the summarized video data, which enables the amount of metadata to be suppressed as much as possible.

The video summarization apparatus may be realized by using, for example, a general-purpose computer system as basic hardware. Specifically, storage means the computer unit has is used as the video data storing unit 101 and metadata storing unit 102. The processor provided in the computer system executes program including the individual processing steps of the condition input unit 100, summarized video generation unit 103, narrative generation unit 104, narrative output unit 105, reproduction unit 106, audio cut detection unit 107, audio segment extraction unit 108, video segment control unit 109, volume control unit 700, and audio segment control unit 900. At this time, the video summarization apparatus may be realized by installing the program in the computer system in advance. The program may be stored in a storage medium, such as a CD-ROM. Alternatively, the program may be distributed through a network and be installed in a computer system as needed, thereby realizing the video summarization apparatus. Furthermore, the video data storing unit 101 and metadata storing unit 102 may be realized by using the memory and hard disk built in the computer system, an external memory and hard disk connected to the computer system, or a storage medium, such as CD-R, CD-RM, DVD-RAM, or DVD-R, as needed.

What is claimed is:

1. A video summarization apparatus comprising:
a first memory to store video data including video and audio;
a second memory to store a plurality of metadata items corresponding to a plurality of video segments included in the video data respectively, each of the metadata items including a keyword and characteristic information of content of corresponding video segment;
a selecting unit configured to select metadata items each including a specified keyword from the metadata items, to obtain selected metadata items;
a first extraction unit configured to extract, from the video data, video segments corresponding to the selected metadata items, to obtain extracted video segments;
a generation unit configured to generate summarized video data by connecting extracted video segments in time series;
a detection unit configured to detect a plurality of audio breakpoints included in the video data, to obtain a plurality of audio segments segmented by the audio breakpoints;
a second extraction unit configured to extract, from the video data, audio segments corresponding to the extracted video segments as audio narrations, to obtain extracted audio segments; and
a modifying unit configured to modify an ending time of a video segment in the summarized video data so that the ending time of the video segment in the summarized video data coincides with or is later than an ending time of corresponding audio segment of the extracted audio segments.

2. The apparatus according to claim 1, wherein the each of the metadata items includes an occurrence time of an event occurred in corresponding video segment.

3. The apparatus according to claim 1, further comprising:
a narrative generation unit configured to generate a narrative of the summarized video data based on the selected metadata items; and
a speech generation unit configured to generate a synthesized speech corresponding to the narrative.

4. The apparatus according to claim 1, wherein the detection unit detects the audio breakpoints each of which is an arbitrary time point in a silent segment where magnitude of audio of the video data is smaller than a predetermined value.

5. The apparatus according to claim 1, wherein the detection unit detects the audio breakpoints based on change of speakers in audio of the video data.

6. The apparatus according to claim 1, wherein the detection unit detects the audio breakpoints based on a pause in an audio sentence or phrase of the video data.

7. The apparatus according to claim 2, wherein the second extraction unit extracts the audio segments each including the occurrence time included in each of the selected metadata items.

8. The apparatus according to claim 3, wherein the second extraction unit extracts the audio segments each including content except for the narrative by speech-recognizing each of the audio segments in the neighborhood of the each of the extracted video segments in the summarized video data.

9. The apparatus according to claim 3, wherein the second extraction unit extracts the audio segments each including content except for the narrative by using closed caption information in each audio segment in the neighborhood of the each of the extracted video segments in the summarized video data.

10. The apparatus according to claim 1, wherein the modifying unit modifies a beginning time and the ending time of the video segment in the summarized video data so that the beginning time and the ending time of the video segment coincide with or includes a beginning time and the ending time of the corresponding audio segment of the extracted audio segment.

11. The apparatus according to claim 1, further comprising a sound volume control unit configured to set sound volume of each audio narration within corresponding video segment in the summarized video data including the video segment modified by the modifying unit larger than sound volume of audio except for the each audio narration within the corresponding video segment.

12. The apparatus according to claim 1, further comprising an audio segment control unit configured to shift temporal position for reproducing an audio segment of the extracted audio segments so that the temporal position lie within corresponding video segment in the summarized video data, when an ending time or a starting time of the audio segment of the extracted audio segments is later than an ending time of the corresponding video segment or earlier than a starting time of the corresponding video segment and length of the audio segment of the extracted audio segments is equal to or shorter than length of the corresponding video segment, and
wherein the modifying unit modifies the ending time of the video segment in the summarized video data, when the ending time of the corresponding audio segment of the extracted audio segments is later than the ending time of the video segment and length of the corresponding audio segment of the extracted audio segments is longer than length of the video segment.

13. The apparatus according to claim 12, further comprising a sound volume control unit configured to set sound volume of each audio narration within corresponding video segment in the summarized video data including the video segment modified by the modifying unit and the audio segment of the extracted audio segments whose temporal position is shifted by the audio segment control unit larger than sound volume of audio except for the each audio narration within the corresponding video segment.

14. A video summarization method including:
storing video data including video and audio in a first memory;
storing, in a second memory, a plurality of metadata items corresponding to a plurality of video segments included in the video data respectively, each of the metadata items including a keyword and characteristic information of content of corresponding video segment;
selecting metadata items each including a specified keyword from the metadata items, to obtain selected metadata items;
extracting, from the video data, video segments corresponding to the selected metadata items, to obtain selected video segments;
generating summarized video data by connecting the extracted video segments in time series;
detecting a plurality of audio breakpoints included in the video data, to obtain a plurality of audio segments segmented by the audio breakpoints;
extracting, from the video data, audio segments corresponding to the extracted video segments as audio narrations; and
modifying an ending time of a video segment in the summarized video data so that the ending time of the video segment in the summarized video data coincides with or is later than an ending time of corresponding audio segment of the extracted audio segments.

15. The method according to claim 14, further including:
setting sound volume of each audio narration within corresponding video segment in the summarized video data including the video segment modified larger than sound volume of audio except for the each audio narration within the corresponding video segment.

16. The method according to claim 14, further including:
shifting temporal position for reproducing an audio segment of the extracted audio segments so that the temporal position lie within corresponding video segment in the summarized video data, when an ending time or a starting time of the audio segment of the extracted audio segments is later than an ending time of the corresponding video segment or earlier than a starting time of the corresponding video segment and length of the audio segment of the extracted audio segments is equal to or shorter than length of the corresponding video segment, and
wherein modifying modifies the ending time of the video segment in the summarized video data, when the ending time of the corresponding audio segment of the extracted audio segments is later than the ending time of the video segment and length of the corresponding audio segment extracted is longer than length of the video segment.

17. The method according to claim 16, further including:
setting sound volume of the audio narration within corresponding video segment in the summarized video data including the video segment modified and the audio segment of the extracted audio segments whose temporal position is shifted larger than sound volume of audio except for the each audio narration within the corresponding video segment.
